(19) United States
(12) Patent Application Publication
(10) Pub. No.: US 2019/0047888 A1
(43) Pub. Date: Feb. 14, 2019

(54) TAIL WATER DECENTRALIZED TREATMENT AND DRAINAGE SYSTEM OF SEWAGE TREATMENT PLANT

(71) Applicant: Powerchina Huadong Engineering Corporation Limited, Zhejiang (CN)

(72) Inventors: Yi JIN, Zhejiang (CN); Sheng SHENG, Zhejiang (CN); Yunling DU, Zhejiang (CN); Jun LI, Zhejiang (CN); Shuxin WU, Zhejiang (CN)

(21) Appl. No.: 16/103,691

(22) Filed: Aug. 14, 2018

(30) Foreign Application Priority Data
Aug. 14, 2017 (CN) 201721008278.9

(51) Int. Cl. C02F 3/32; C02F 1/00; B01D 24/22

(52) U.S. Cl. CPC C02F 3/327; C02F 1/004; B01D 2101/04; C02F 2307/00; B01D 24/22

(57) ABSTRACT

The present invention provides a tail water decentralized treatment and drainage system of sewage treatment plant, comprising a riparian vegetation buffer zone, a subsurface flow constructed wetland and a riverside protection pile, the riparian vegetation buffer zone comprises an excavation protection slope and an ecological bag paved on the excavation protection slope. The subsurface flow constructed wetland is disposed on the river protection slope along the river flow direction, the subsurface flow constructed wetland is provided with a treatment system, a water drainage system and a plurality of outlet pipes disposed along the river flow direction. The present invention is novel in idea and reasonable in design. By constructing a subsurface flow constructed wetland on the slope of the river bank after repositioning, the vegetation buffer zone and the subsurface flow constructed wetland are skillfully combined, and the tail water of sewage treatment plants is purified and treated through the subsurface flow constructed wetland. It is particularly suitable for changing the condition of single drainage outlet for the sewage treatment plant constructed near the river, with strong practicability.

### FIELD OF THE INVENTION

The invention relates to a deep purification and a decentralized treatment and drainage system for tail water of urban sewage treatment plants, and in particular to a tail water decentralized treatment and drainage system of sewage treatment plant that is applied to the technical field of ecological environmental engineering.

### BACKGROUND

At present, the national standard for the discharge of pollutants from urban sewage treatment plants in China is GB18918-2002, with grade A as the highest standard. With the rapid growth of China's economy and the introduction of the concept of ecological civilization construction, the national requirements for the quality of the water environment have become increasingly stringent. In some areas with good water environment quality, if the grade A discharge standard of pollutants in the urban sewage treatment plants is implemented, it will lead to continuous decline in water environment quality, which is apparently unable to meet the requirements for the water environment functional zoning. If an urban sewage treatment plant is expanded or reconstructed, or upgraded, it will usually need high investment but the effect may be not obvious, which does not comply with the requirement of ecological water control. In the urban sewage treatment plants, usually the treated sewage is collected to a main drainage pipe and then discharged into a river nearby. Therefore, the point source pollution of the water outlets of urban sewage treatment plants is more serious. For sewage treatment plants whose sewage is discharged from a concentrated place, when the effluent water quality of the wastewater treatment plant is unstable, there are drawbacks of sudden deterioration of water quality at the sewage outlet and its downstream, low transparency and more foams, etc., affecting the sensory effect of water body and water quality assessment.

### SUMMARY

The technical problem to be solved by the present invention is to provide a decentralized treatment and drainage system with low operating cost and low energy consumption that is capable of improving the tail water quality of sewage treatment plants. To achieve this object, the present invention adopts the following technical solutions:

A tail water decentralized treatment and drainage system of sewage treatment plant, comprising a riparian vegetation buffer zone, a subsurface flow constructed wetland and a riverside protection pile; the riparian vegetation buffer zone comprises an excavation protection slope, and an ecological bag is paved on the surface of the excavation protection slope, an intercepting ditch is provided between the riparian vegetation buffer zone and the subsurface flow constructed wetland; the subsurface flow constructed wetland has a water inlet system and a water drainage system;

The subsurface flow constructed wetland is disposed on the river protection slope along the river flow direction, the subsurface flow constructed wetland is provided with a treatment system, a water drainage system and a plurality of outlet pipes disposed along the river flow direction;

Tail water discharged from a sewage treatment plant enters a treatment system of the subsurface flow constructed wetland through the water inlet system, and the outlet water at the bottom of the subsurface flow constructed wetland enters the water drainage system to discharge to a river through the plurality of outlet pipes.

While adopting the foregoing technical solutions, the present invention further adopts or combines the following technical solutions:

The slope of the excavation protection slope is between 1:1.5 and 1:3, and forms a stepped soil slope structure, and the ecological bag is placed on the soil slope structure layer by layer.

The ecological bag contains an outer packaging bag, the bag is provided with mixed packing.

The outer packaging bag is made of a geotextile material that is non-woven fabric and needled into a net; the mixed packing contains cultivated soil and grass seeds, suitable for plant growth; a three-dimensional coupling buckle is used to connect ecological bags, an ecological bag and an excavation protection slope; the adjacent ecological bags are mutually connected and the ecological bag is connected with the excavation protection slope by the three-dimensional coupling buckle using spur structures on the upper and lower surfaces thereof, to form a stable triangular internal friction and contraction structure.

The water inlet system comprises a water inlet manifold, a valve well, a valve and a diverting pipe; the treatment system comprises a wetland structure, a filter bed purification unit, a wetland plant, and the wetland plant is planted above the filter bed purification unit, the water drainage system comprises a water outlet regulating pond, an outlet pipe, and an air duct;

The diverting pipe is introduced to the upper part of the filter bed purging unit; the air duct is introduced to the bottom of the filter bed purification unit, and communicated through a communicating pipe at the bottom, and the communicating pipe is provided with a vent hole.

The treatment system of the subsurface flow constructed wetland is provided by units, a plurality of treatment units are provided along the river flow direction, the water drainage system forms a channel type water outlet regulating pond along a river flow direction, and the plurality of outlet pipes are connected to the water outlet regulating pond.

The three-dimensional coupling buckle comprises a connecting motherboard, an upper burr and a lower burr, the upper burr is in the middle of the upper surface of the connecting motherboard, the lower burr is in the lower surface of the connecting motherboard, and the lower burr is beyond both sides of the upper burr, to form a triangle-arranged structure adapted to the triangular internal friction and contraction structure.

The wetland structure comprises an outer wall, a partition wall, a ground beam and a ring beam; the filter bed purification unit comprises a cushion layer, an impermeable membrane, a geotextile and a multi-graded filter layer from bottom to top;

The wetland structure forms a plurality of unit spaces arranged in the direction of the water flow of the river, and each unit space is provided with the filter bed purification unit.

The outer wall and the partition wall are brick-concrete structures, the ground beam and the ring beam are reinforced concrete structures; the cushion layer comprises a gravel cushion layer, a concrete cushion layer, and a sand cushion layer from the bottom to the top; the impermeable membrane is a high-density polyethylene membrane having a thickness of 1.2 mm; the geotextile has a thickness of 2 mm; the multi-graded filter layer comprises a gravel filter layer with a particle size of 16˜32 mm, a gravel filter layer with a particle size of 8˜16 mm, a zeolite filter layer with a particle size of 5˜8 mm, and a gravel filter layer with a particle size of 8˜16 mm from bottom to top.

The riverside protection pile is a concrete structure, piling into the waterfront of water outlet of the subsurface flow constructed wetland, and arranged linearly along the river bank.

The present invention is novel in idea and reasonable in design. By constructing a subsurface flow constructed wetland on the slope of the river bank after repositioning, the vegetation buffer zone and the subsurface flow constructed wetland are skillfully combined to achieve the conversion from point source centralized discharge to linear decentralized discharge of tail water of sewage treatment plants. The tail water of sewage treatment plants is purified and treated through the subsurface flow constructed wetland, to give full play to the self-purification capability of river water, reduce the pressure of local sewage discharge point of the river and avoid rapid deterioration of water quality. In addition, river environment is rebuilt while managing tail water pollution, to achieve a comprehensive effect at a cost. It is particularly suitable for changing the condition of single drainage outlet for the sewage treatment plant constructed near the river, with strong practicability.

### BRIEF DESCRIPTION OF THE DRAWINGS

FIG. 1 is a schematic view of a tail water decentralized treatment and drainage system of sewage treatment plant according to the present invention.

FIG. 2 is a schematic sectional view of a tail water decentralized treatment and drainage system of sewage treatment plant according to the present invention.

FIG. 3 is a schematic view of a single-layer ecological bag of the present invention.

FIG. 4 is a sectional view of an ecological bag of the present invention.

FIG. 5 is a schematic view of an ecological protection slope stacked by ecological bag of the present invention.

FIG. 6 is a schematic view of a structure of a riverside protection pile of the present invention.

Notes: riparian vegetation buffer zone 1, subsurface flow constructed wetland 2, riverside protection pile 3, excavation protection slope 4, ecological bag 5, intercepting ditch 6, water inlet system 7, treatment system 8, water drainage system 9, outer packaging bag 10, mixed packing in the bag 11, three-dimensional coupling buckle 12, water inlet manifold 13, valve well 14, diverting pipe 16, wetland structure 17, filter bed purification unit 18, wetland plant 19, water outlet regulating pond 20, outlet pipe 21, air duct 22, communicating pipe 23, outer wall 27, partition wall 28, ground beam 29, ring beam 30, cushion layer 31, impermeable membrane 32, geotextile 33, multi-graded filter layer 34, gravel cushion layer 35, concrete cushion layer 36, sand cushion layer 37, gravel filter layer with particle size of 16˜32 mm 38, gravel filter layer with particle size of 8˜16 mm 39, zeolite filter layer with particle size of 5˜8 mm 40, gravel filter layer with particle size of 8˜16 mm 41.

### DETAILED DESCRIPTION

The present invention is described in detail in combination with attached drawings and embodiments.

The present invention provides a tail water decentralized treatment and drainage system of sewage treatment plant, comprising a riparian vegetation buffer zone 1, a subsurface flow constructed wetland 2 and a riverside protection pile 3.

Wherein, the riparian vegetation buffer zone 1 comprises an excavation protection slope 4 and an ecological bag 5 stacked on the excavation protection slope. The runoff inflow pollution caused by rainfall can be effectively reduced by the plant absorption effect of ecological bag 5, to avoid the impact of pollutants in the primary rain on subsurface flow constructed wetland 2. The subsurface flow constructed wetland 2 is arranged on the river protection slope, and the subsurface flow constructed wetland has a water inlet system 7 and a water drainage system 9. The water inlet system 7 introduces the tail water of the sewage treatment plant into the subsurface flow constructed wetland 2 through the water inlet manifold 13, the valve well 14, the valve 15 and the diverting pipe 16, and further purifies the tail water by the physical, chemical and biological effects of the treatment system 8 in the subsurface flow constructed wetland 2, finally the effluent is discharged into the adjacent rivers by the multiple drainage pipes of the water drainage system arranged along the river bank, to achieve the purpose of reduced discharge and decentralized discharge of pollutants in the tail water.

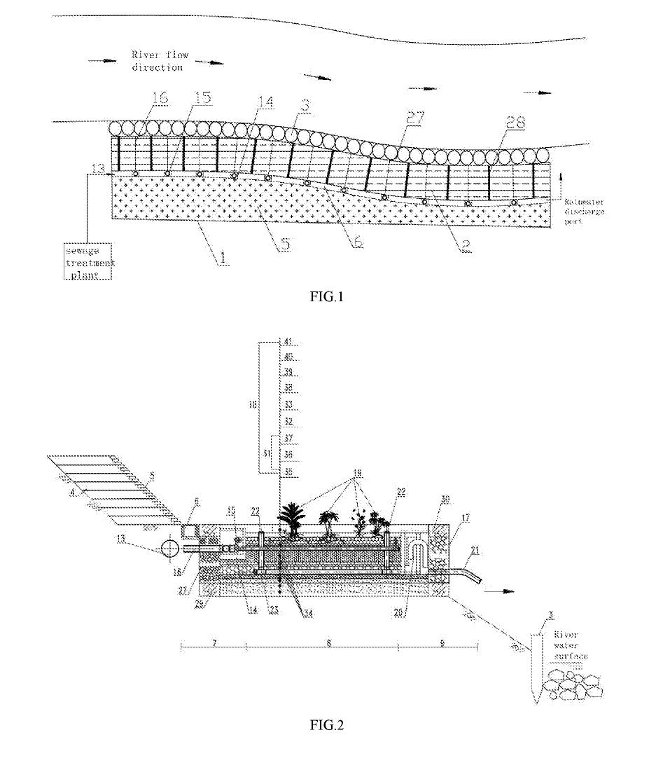

As shown in FIG. 1 and FIG. 2, an ecological bag 5 is paved on the surface of the riparian vegetation buffer zone 1. The green plants grown in the ecological bag have the effect of blocking pollutants from entering the river. In the sunny days, riparian vegetation buffer zone can green the protection slope; and in rainy days, rainfall runoff will slowly pass through the riparian vegetation buffer zone. Contaminants carried by runoff are absorbed by the matrix and green plants in the ecological bag, which can effectively reduce the impact of initial rain erosion on river pollution loads. An intercepting ditch 6 is provided between the riparian vegetation buffer zone and the subsurface flow constructed wetland. In rainy days, the rainwater flowing through the riparian vegetation buffer zone is collected into the intercepting ditch 6. The rain in the intercepting ditch 6 will not enter the subsurface flow constructed wetland 2 but is directly discharged from the rainwater discharge port to the river. On the river protection slope below the riparian vegetation buffer zone 1, a subsurface flow constructed wetland 2 is arranged by terrain remodeling, and the treatment system in the subsurface flow constructed wetland 2 can be divided into a plurality of processing units along the direction of the river flow. The tail water discharged from sewage treatment plants near the river passes through water inlet manifold 13 to enter each wetland treatment unit. The inflow of water can be adjusted and controlled by valve 15 in valve well 14. Water enters all processing units from the diverting pipe 16. The valve well 14 is inside the subsurface flow constructed wetland, preferably, forming a channel-type diversion well along the flow direction of the river. The treatment system 8 in the subsurface flow construct wetland 2 comprises a wetland structure 17, a filter bed purification unit 18, and a wetland plant 19, and the diverting pipe 16 is introducing to the upper part of the filter bed purification unit 18.

The multi-graded filter layer 34 in the subsurface flow construct wetland 2 has the purification effects of adsorption and sedimentation. The wetland plant 19 planted on the surface has effect on absorption and utilization of pollutants. After the tail water passes through the subsurface flow constructed wetland, the nitrogen and phosphorous pollutants and suspended particulate matters have been greatly reduced, finally the wetland effluent is uniformly dispersed and discharged into rivers from various treatment units through the water drainage system 9, changing the original point source discharge from sewage treatment plants.

The water drainage system 9 comprises a water outlet regulating pond 20, an outlet pipe 21, an air duct 22 and a communicating pipe 23. The water outlet regulating pond 20 can stably regulate the amount of water discharged from the subsurface flow constructed wetland based on the siphoning phenomenon of the U-shaped pipe. The effluent from the bottom of the subsurface flow constructed wetland 2 flows into the water outlet regulating pond 20, and then discharge the purified water into rivers through outlet pipe 21 from the water outlet regulating pond 20. The air duct 22 is connected to the bottom of the filter bed purification unit 18, and communicated with the communicating pipe at the bottom, and a vent hole is set in the communicating pipe. The water outlet regulating pond 20 preferably forms a channel type water outlet regulating pond 20 along the river flow direction, and a plurality of outlet pipes 21 are arranged along the river flow direction to achieve drainage in a uniform and distributed manner.

The water inlet manifold 13 is a polyethylene pipe, the valve well 14 is a steel-concrete structure, the valve 15 is an electric valve, the diverting pipe 16 is a spiral welded pipe, and the outlet pipe 21 and the air duct 22 are hard PVC pipes.

The wetland structure 17 comprises an outer wall 27, a partition wall 28, a ground beam 29, and a ring beam 30 (please supplement the positional relationship of the structures in the treatment system). The wetland structure 17 forms a plurality of unit spaces arranged along the direction of the river flow. Each unit space is provided with the filter bed purification unit 18. The filter bed purification unit 18 comprises a cushion layer 31, an impermeable membrane 32, a geotextile 33, and a multi-graded filter layer 34 sequentially from the bottom to the top. The communication portion of the air duct 22 is between the multi-graded filter layer 34 and the cushion layer 31. The wetland plant 19 may include Cyperus alternifolius, Thalia dealbata, cattails, scallions, reeds, and so on.

The outer wall 27 and the partition wall 28 are brick-concrete structures, the ground beam 29 and the ring beam 30 are reinforced concrete structures; the cushion layer 31 comprises a gravel cushion layer 35, a concrete cushion layer 36 and a sand cushion layer 37 from bottom to top; the impermeable membrane 32 is a high-density polyethylene membrane having a thickness of 1.2 mm; the geotextile 33 has a thickness of 2 mm; and the multi-graded filter layer 34 comprises a gravel filter layer 38 with a particle size of 16˜32 mm, a gravel filter layer 39 with a particle size of 8˜16 mm, a zeolite filter layer 40 with a particle size of 5˜8 mm, and a gravel filter layer 41 with a particle size of 8˜16 mm from bottom to top. The multiple grades of the filter material can increase the stability between layers. The multi-graded filter layer 34 is the core part of the wastewater treatment system 8, of which, the zeolite filter layer 40 with a particle size of 5˜8 mm has the strongest pollutant removal capability.

As shown in FIG. 2, the slope of the excavation slope 4 is controlled between 1:1.5 and 1:3. The slope of the protection slope is trimmed toward the river surface to remove large rock blocks and loose layers in the protection slope. The soil slope is compacted and leveled mechanically to form a stepped soil slope structure, and the ecological bag 5 is piled and paved on the surface of the soil slope structure.

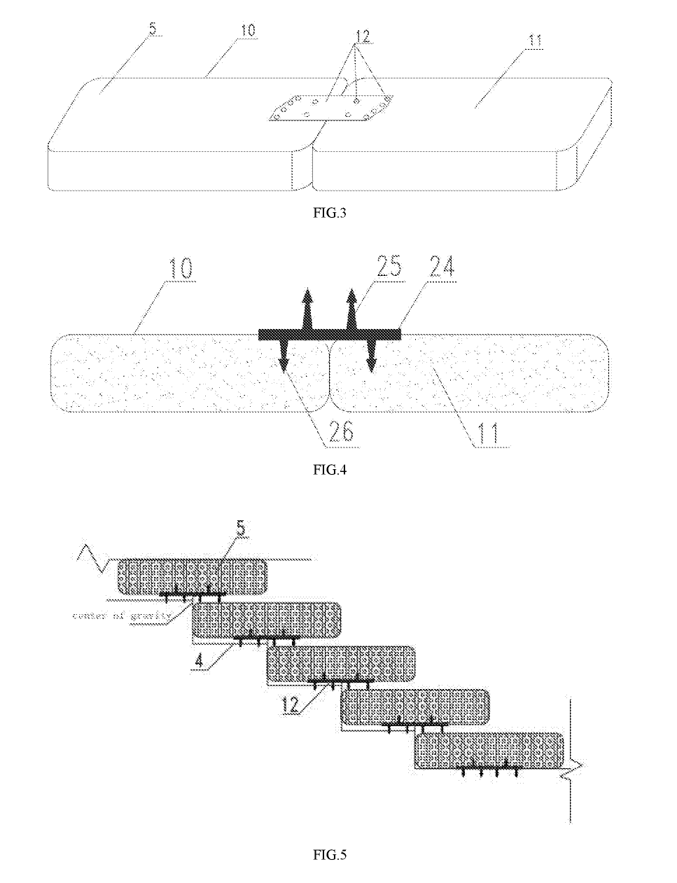

As shown in FIG. 3 and FIG. 4, the ecological bag 5 includes an outer packaging bag 10 in which a mixed packing 11 is provided. The raw material of the outer packaging bag 10 is a non-woven geotextile material made of polypropylene artificial fibers that are needled into net; using the spur structures of three-dimensional coupling buckle 12 at the upper and lower surfaces, the ecological bags are interconnected, to form a stable triangular internal friction and contraction structure; the three-dimensional coupling buckle comprises a connecting motherboard 24 and an upper burr 25 and a lower burr 26, the upper burr is in the middle of the upper surface of the connecting motherboard, the lower burr is in the lower surface of the connecting motherboard, and the lower burr is beyond both sides of the upper burr, to form a triangle-arranged structure adapted to the triangular internal friction and contraction structure.

The mixed packing in the bag adopts clean granular mixture suitable for plant growth, about 30% of the packing is gravel, and about 70% is cultivated soil. 10 to 15 g of grass seeds are mixed per square meter, when germinating in the ecological bag, grass seeds will come out of the surface of the outer packaging bag and grow rapidly, to form dense green vegetation. When splicing the ecological bag horizontally, the edges of the ecological bag should be tightly aligned, and then the outer packaging bag of the ecological bag should be pierced with the spur structure of the three-dimensional coupling buckle, to prevent affecting the structural stability of ecological bags due to dislocation.

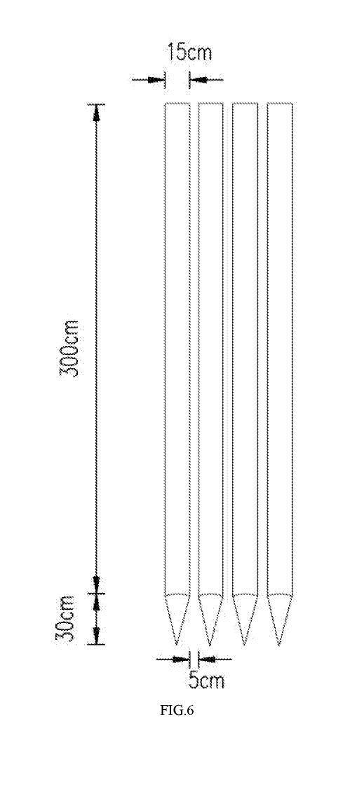

As shown in FIG. 5, when the riparian vegetation buffer zone 1 is constructed, terrain remodeling is required. Firstly the stepped soil slope structure, i.e. the excavation protection slope 4 is constructed, to make the slope within the range of 1:1.5 to 1:3, then the ecological bags are paved from the lowest layer. When paving ecological bags, the ecological bag and the slope surface are fixed using a three-dimensional coupling buckle 12, when the lateral horizontal laying is completed, the second layer is paved. When paving the second layer of ecological bag, two spur structures on the upper surface of the three-dimensional coupling buckle are pierced into the lower surface of the second layer of the ecological bag, and two spur structures on the lower surface of the three-dimensional coupling buckle are pierced into the slope. The other two spur structures are pierced into the upper surface of the first layer of the ecological bag. When fixing the second layer of ecological bag, ensure that its center of gravity falls on the vertical line of the slope. Afterwards, paving is performed according to the similar methods.

As shown in FIG. 1 and FIG. 6, the riverside protection pile 3 is arranged at the foot of the river along the river line linearly, to protect the outer wall of the protection bank and wetland from erosions of ship waves or high water level. The riverside protection pile 3 is a concrete structure with a diameter of 15 cm and a length of 300 cm. The bottom conical structure is 30 cm in length. When piling, the riverside protection pile 3 is driven into the bottom of the river sludge by 1 meter and about 2 meters above the water surface. The distance between two adjacent riverside protection piles is 5 cm, to discharge the effluent of the subsurface flow constructed wetland without obstruction. The exposed water film portion of the riverside protection pile 3 can adopt a simulated pine surface structure.

The foregoing descriptions are merely specific embodiments of the present invention, but the structural features of the present invention are not limited thereto. Any changes or modifications made by those skilled in the art within the scope of the present invention shall fall within the scope of protection of the present invention.

1. A tail water decentralized treatment and drainage system of sewage treatment plant, comprising a riparian vegetation buffer zone (1), a subsurface flow constructed wetland (2) and a riverside protection pile (3); the riparian vegetation buffer zone (1) comprises an excavation protection slope (4), and an ecological bag (5) is paved on the surface of the excavation protection slope (4), an intercepting ditch (6) is provided between the riparian vegetation buffer zone (1) and the subsurface flow constructed wetland (2); the subsurface flow constructed wetland (2) has a water inlet system (7) and a water drainage system (9);
The subsurface flow constructed wetland (2) is disposed on the river protection slope along the river flow direction, the subsurface flow constructed wetland is provided with a treatment system (8), and a water drainage system and a plurality of outlet pipes disposed along the river flow direction;
Tail water discharged from a sewage treatment plant enters a treatment system (8) of the subsurface flow constructed wetland (2) through the water inlet system (7), and the outlet water at the bottom of the subsurface flow constructed wetland (2) enters the water drainage system to discharge to a river through the plurality of outlet pipes.

2. The tail water decentralized treatment and drainage system of sewage treatment plant according to claim 1, wherein the slope of the excavation protection slope (4) is between 1:1.5 and 1:3, and forms a stepped soil slope structure, and the ecological bag (5) is placed on the soil slope structure layer by layer.

3. The tail water decentralized treatment and drainage system of sewage treatment plant according to claim 1, wherein the ecological bag (5) contains an outer packaging bag (10), the bag is provided with mixed packing (11);
The outer packaging bag (10) is made of a geotextile material that is non-woven fabric and needled into a net; the mixed packing contains cultivated soil and grass seeds, suitable for plant growth; a three-dimensional coupling buckle (12) is used to connect ecological bags (5), an ecological bag (5) and an excavation protection slope (4); the adjacent ecological bags are mutually connected and the ecological bag is connected with the excavation protection slope (4) by the three-dimensional coupling buckle (12) using spur structures on the upper and lower surfaces thereof, to form a stable triangular internal friction and contraction structure.

4. The tail water decentralized treatment and drainage system of sewage treatment plant according to claim 1, wherein the water inlet system (7) comprises a water inlet manifold (13), a valve well (14), a valve (15) and a diverting pipe (16); the treatment system (8) comprises a wetland structure (17), a filter bed purification unit (18), a wetland plant (19), and the wetland plant (19) is planted above the filter bed purification unit (18), the water drainage system (9) comprises a water outlet regulating pond (20), an outlet pipe (21), and an air duct (22);
The diverting pipe (16) is introduced to the upper part of the filter bed purging unit; the air duct (22) is introduced to the bottom of the filter bed purification unit, and communicated through a communicating pipe (23) at the bottom, and the communicating pipe is provided with a vent hole.

5. The tail water decentralized treatment and drainage system of sewage treatment plant according to claim 1, wherein the treatment system of the subsurface flow constructed wetland (2) is provided by units, a plurality of treatment units are provided along the river flow direction, the water drainage system (9) forms a channel type water outlet regulating pond along a river flow direction, and the plurality of outlet pipes (21) are connected to the water outlet regulating pond (20).

6. The tail water decentralized treatment and drainage system of sewage treatment plant according to claim 3, wherein the three-dimensional coupling buckle (12) comprises a connecting motherboard (24), an upper burr (25) and a lower burr (26), the upper burr (25) is in the middle of the upper surface of the connecting motherboard (24), the lower burr (26) is in the lower surface of the connecting motherboard (24), and the lower burr (26) is beyond both sides of the upper burr (25), to form a triangle-arranged structure adapted to the triangular internal friction and contraction structure.

7. The tail water decentralized treatment and drainage system of sewage treatment plant according to claim 4, wherein the wetland structure (17) comprises an outer wall (27), a partition wall (28), a ground beam (29) and a ring beam (30); the filter bed purification unit (18) comprises a cushion layer (31), an impermeable membrane (32), a geotextile (33) and a multi-graded filter layer (34) from bottom to top;
The wetland structure (17) forms a plurality of unit spaces arranged in the direction of the water flow of the river, and each unit space is provided with the filter bed purification unit (18).

8. The tail water decentralized treatment and drainage system of sewage treatment plant according to claim 8, wherein the outer wall (27) and the partition wall (28) are brick-concrete structures, the ground beam (29) and the ring beam (30) are reinforced concrete structures; the cushion layer (31) comprises a gravel cushion layer (35), a concrete cushion layer (36), and a sand cushion layer (37) from the bottom to the top; the impermeable membrane (32) is a high-density polyethylene membrane having a thickness of 1.2 mm; the geotextile (33) has a thickness of 2 mm; the multi-graded filter layer (34) comprises a gravel filter layer (38) with a particle size of 16˜32 mm, a gravel filter layer (39) with a particle size of 8˜16 mm, a zeolite filter layer (40) with a particle size of 5˜8 mm, and a gravel filter layer (41) with a particle size of 8˜16 mm from bottom to top.

9. The tail water decentralized treatment and drainage system of sewage treatment plant according to claim 1, wherein the riverside protection pile (3) is a concrete structure, piling into the waterfront of water outlet of the subsurface flow constructed wetland (2), and arranged linearly along the river bank.
